(19) United States
(12) Patent Application Publication
(10) Pub. No.: US 2026/0219153 A1
(43) Pub. Date: Jul. 30, 2026

(54) FIELD FLOW FRACTIONATION APPARATUS

(71) Applicant: SHIMADZU CORPORATION, Kyoto-shi (JP)

(72) Inventor: Yukio OIKAWA, Kyoto-shi (JP)

(73) Assignee: SHIMADZU CORPORATION, Kyoto-shi (JP)

(21) Appl. No.: 19/397,093

(22) Filed: Nov. 21, 2025

(30) Foreign Application Priority Data
Nov. 28, 2024 (JP) 2024-207011

(51) Int. Cl. G01N 15/02

(52) U.S. Cl. CPC G01N 15/0266; G01N 2015/0288

(57) ABSTRACT

A field flow fractionation apparatus according to the present disclosure classifies particles contained in a sample. The field flow fractionation apparatus includes a flow cell, a fluid supply unit, a sample introduction unit, and a magnetic field generation unit. The flow cell constitutes a flow channel through which the particles flow. The fluid supply unit supplies a fluid to the flow channel. The sample introduction unit supplies the sample to the flow channel. The magnetic field generation unit generates a magnetic field that acts on the flow channel.

### TECHNICAL FIELD

The present disclosure relates to a field flow fractionation apparatus, and more particularly, to separating multiple types of particles that exhibit different behaviors with respect to a magnetic field in field flow fractionation.

### BACKGROUND ART

Field flow fractionation (FFF) is known as a classification method for separating fine particles in a solution according to their size. The FFF method is a method for classifying multiple types of particles based on the diffusion coefficient of each fine particle in a solution, without using a stationary phase in the separation layer. As one type of FFF method, for example, as disclosed in Japanese Unexamined Patent Application Publication No. 2008-000724 (Patent Literature 1), asymmetrical flow field-flow fractionation (AF4), which is a cross-flow type classification method employing an asymmetric channel structure, is known.

### SUMMARY OF INVENTION

### TECHNICAL PROBLEM

In the AF4 method, particles are classified by utilizing the difference in diffusion coefficients due to the particle size of the particles. Therefore, it may be difficult for the AF4 method to separate particles of different types that have the same particle size.

The present disclosure has been made in view of such circumstances, and an object thereof is to separate multiple types of particles that exhibit different behaviors with respect to a magnetic field in field flow fractionation.

### SOLUTION TO PROBLEM

A field flow fractionation apparatus according to an aspect of the present disclosure is a field flow fractionation apparatus for classifying particles contained in a sample, the apparatus comprising: a flow cell that constitutes a flow channel through which the particles flow; a fluid supply unit that supplies a fluid to the flow channel; a sample introduction unit that introduces the sample into the flow channel; and a magnetic field generation unit that generates a magnetic field acting on the flow channel.

### ADVANTAGEOUS EFFECTS OF INVENTION

According to the present disclosure, it is possible to separate multiple types of particles that exhibit different behaviors with respect to a magnetic field in field flow fractionation.

### BRIEF DESCRIPTION OF DRAWINGS

FIG. 1 is a schematic diagram illustrating a configuration of a field flow fractionation apparatus according to the present embodiment.

FIG. 2 is an exploded perspective view showing the structure of a flow cell according to the present embodiment.

FIG. 3 is a cross-sectional view of the flow cell according to the present embodiment.

FIG. 4 is a schematic diagram illustrating a configuration of a field flow fractionation apparatus according to a comparative example.

FIG. 5 is a flowchart of particle classification by the field flow fractionation apparatus according to the present embodiment.

FIG. 6 is a cross-sectional view of a flow cell in a modified example.

FIG. 7 is a diagram showing fractograms of particles in an experimental example.

### DESCRIPTION OF EMBODIMENTS

Hereinafter, embodiments of the present disclosure will be described in detail with reference to the drawings. Note that the same or corresponding parts in the drawings are denoted by the same reference numerals, and a description thereof will not be repeated.

### Apparatus Configuration

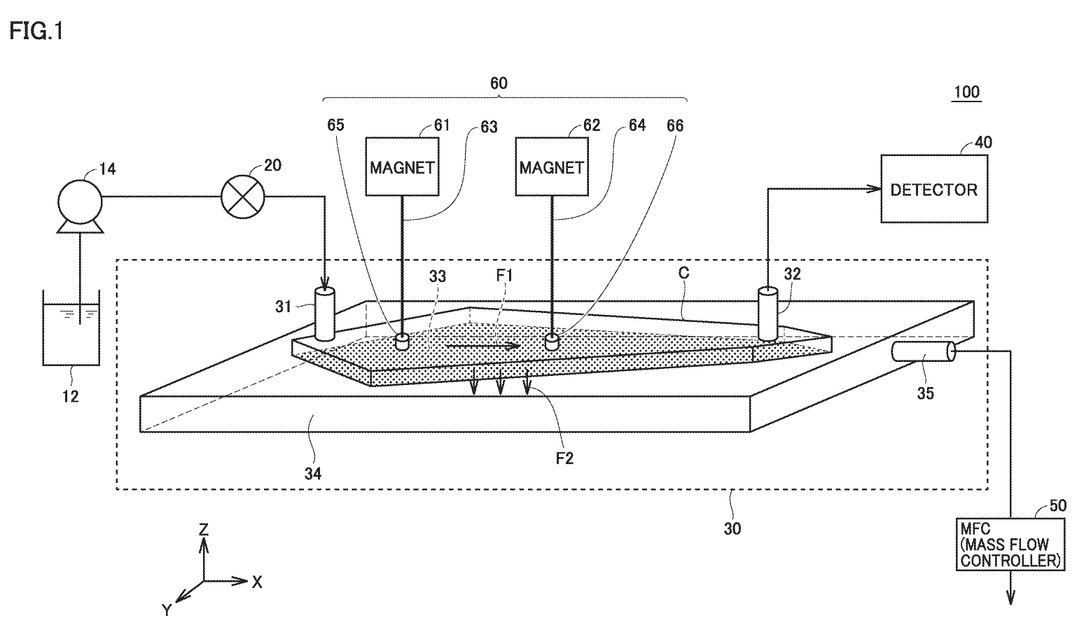

First, the configuration of an FFF apparatus 100 according to the embodiment will be described. FIG. 1 is a schematic diagram for explaining the configuration of the FFF apparatus according to the embodiment. The FFF apparatus 100 can classify particles in a sample. The sample is not particularly limited, but is, for example, a biopharmaceutical, and in that case, the FFF apparatus is used, for example, for the measurement and/or evaluation of aggregates in the biopharmaceutical. The particle size of the particles to be classified is not particularly limited, but for example, the particle size is 1 nm to 50 μm.

Referring to FIG. 1, the FFF apparatus 100 includes a container 12, a liquid feed pump 14, a sample introduction unit 20, a flow cell 30, a detector 40, a mass flow controller (MFC) 50, and a magnetic field generation unit 60.

The container 12 stores a fluid for forming a flow field for classifying particles. The fluid is, for example, water, an aqueous solution, or an organic solvent (e.g., THF and toluene).

The liquid feed pump 14 sends the fluid stored in the container 12 to the flow cell 30. The container 12 and the liquid feed pump 14 correspond to a fluid supply unit that supplies the fluid to the flow cell 30.

The sample introduction unit 20 introduces a sample to be separated into the FFF apparatus 100. The sample introduction unit 20 is provided in the middle of a flow path connecting the liquid feed pump 14 and the flow cell 30. The sample introduced into the flow path is introduced into the flow cell 30 together with the fluid sent from the liquid feed pump 14.

The flow cell 30 constitutes a flow channel through which the particles in the sample flow. Inside the flow cell 30, a flow field is formed, and the particles in the sample are classified. The flow cell 30 includes an inlet port 31, an outlet port 32, a separation membrane 33, a base 34, and a discharge port 35.

Inside the flow cell 30, a separation channel C through which the fluid and the particles in the sample flow is formed. The separation channel C has a substantially rhombic shape. An inlet port 31 and an outlet port 32 are provided at respective ends of the longer diagonal of the separation channel C. The inlet port 31 is connected to the liquid feed pump 14, and the outlet port 32 is connected to the detector 40. The fluid is supplied from the inlet port 31 to the separation channel C. The fluid that has reached the outlet port 32 proceeds to the detector 40. The separation channel C corresponds to a flow channel through which the fluid and the particles in the sample flow.

In the following description, the direction along the line connecting the inlet port 31 and the outlet port 32 is defined as the X-axis direction, and the plane on which the flow cell 30 is provided is defined as the XY plane. Furthermore, the direction perpendicular to the XY plane is defined as the Z-axis direction. The positive direction of the Z-axis may be referred to as the upper side, and the negative direction as the lower side.

The length (thickness) of the separation channel C in the Z-axis direction is 1 mm or less. Due to the geometric shape of the separation channel C, the flow F1 of the fluid introduced from the inlet port 31 and directed toward the outlet port 32 becomes a laminar flow. In the laminar flow F1, the fluid flows in layers parallel to the XY plane, and there is no turbulence between the layers. Among the layered flows, the flow becomes faster toward the center in the Z-axis direction. The flow F1 is referred to as "channel flow."

The separation membrane 33 is a semipermeable membrane having a plurality of pores. The separation membrane 33 includes, for example, regenerated cellulose (RC) or polyethersulfone (PES). In the separation channel C, one wall surface parallel to the channel flow F1 is constituted by the separation membrane 33, which has the property of transmitting the fluid but not the particles in the sample. In FIG. 1, the separation membrane 33 is disposed on the lower side (bottom surface) of the separation channel C. Since a part of the fluid introduced into the separation channel C permeates the separation membrane 33, a flow F2 in the Z-axis direction orthogonal to the flow F1 is generated in the separation channel C. The flow F2 is referred to as "cross-flow."

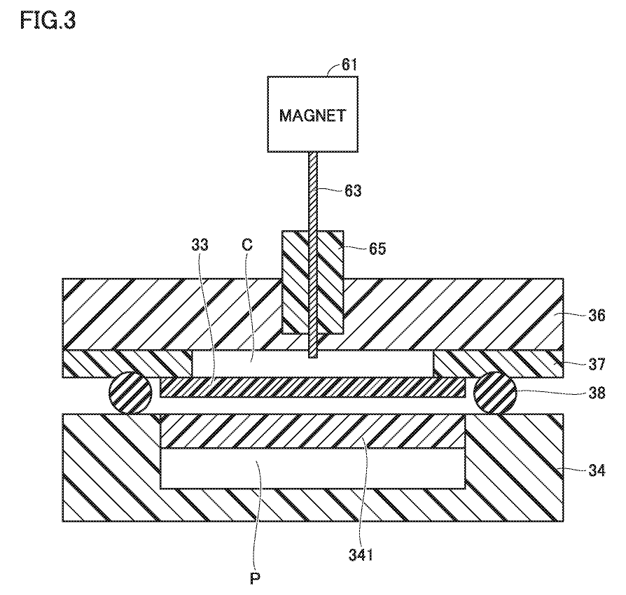

The fluid that has permeated the separation membrane 33 flows through a flow path (not shown) in the base 34 provided on the lower side of the separation channel C and is discharged to the outside from a discharge port 35. An MFC 50 is provided on the flow path connected to the discharge port 35, and the flow rate of the fluid discharged from the flow path in the base 34 is detected by the MFC 50. The flow path in the base 34 will be described with reference to FIG. 3.

The MFC 50 adjusts the flow rate of the fluid discharged from the discharge port 35. This changes the flow rate of the fluid passing through the separation membrane 33. Therefore, the MFC 50 can adjust the flow rate of the cross-flow by adjusting the flow rate of the fluid discharged from the discharge port 35.

The detector 40 performs analysis on the eluted particles. The type of the detector 40 is not limited, and its type can be selected according to the analysis method desired by the user. The detector 40 is, for example, an ultraviolet detector, a fluorescence detector, a refractive index detector, a dynamic scattering detector, a multi-angle light scattering detector, or a conductivity detector.

The magnetic field generation unit 60 generates a magnetic field that acts on the separation channel C.

The magnetic field generation unit 60 includes a magnet 61, a magnet 62, a wire 63, a wire 64, a fitting member 65, and a fitting member 66.

The magnet 61 and the magnet 62 generate a magnetic field. The magnet 61 and the magnet 62 are, for example, permanent magnets. The permanent magnet is, for example, a neodymium magnet. It is preferable that the neodymium magnet is 0.2 T (tesla) or more.

The wire 63 and the wire 64 transmit the magnetic field generated from the magnet 61 and the magnet 62 into the separation channel C by magnetization. The wire 63 and the wire 64 have the property of being magnetized, and are preferably ferromagnetic materials such as iron, nickel, or cobalt. The surfaces of the wire 63 and the wire 64 may be covered with a rust inhibitor, a metal that is difficult to oxidize (e.g., platinum and iridium), or an oxide film (e.g., black rust). The wire 63 and the wire 64 correspond to transmission members.

The fitting member 65 and the fitting member 66 fix the positions of the wire 63 and the wire 64.

Although the FFF apparatus 100 in the present embodiment has been described with an example in which the fluid is supplied only from the inlet port 31, the fluid may be configured to be supplied from the outlet port 32 or an intermediate port provided between the inlet port 31 and the outlet port 32. When the fluid is supplied into the separation channel C simultaneously from the inlet port 31 and the outlet port 32 or the intermediate port, a flow opposing the channel flow is generated in the separation channel C. This flow is referred to as "focus flow." By generating the focus flow, the particles in the sample can be collected at a certain position. This can improve the accuracy of particle classification. The outlet port 32 and the intermediate port may be configured such that fluid is supplied from the container 12, or may be configured such that fluid is supplied from a container different from the container 12. Further, a liquid feed pump different from the liquid feed pump 14 may be connected to the outlet port 32 and the intermediate port, or the liquid feed pump 14 may be connected to these ports via a switching mechanism such as a rotary valve, and the switching mechanism may be configured to switch between a state where the liquid feed pump 14 is connected only to the inlet port 31 and a state where it is connected to both the outlet port 32 or the intermediate port.

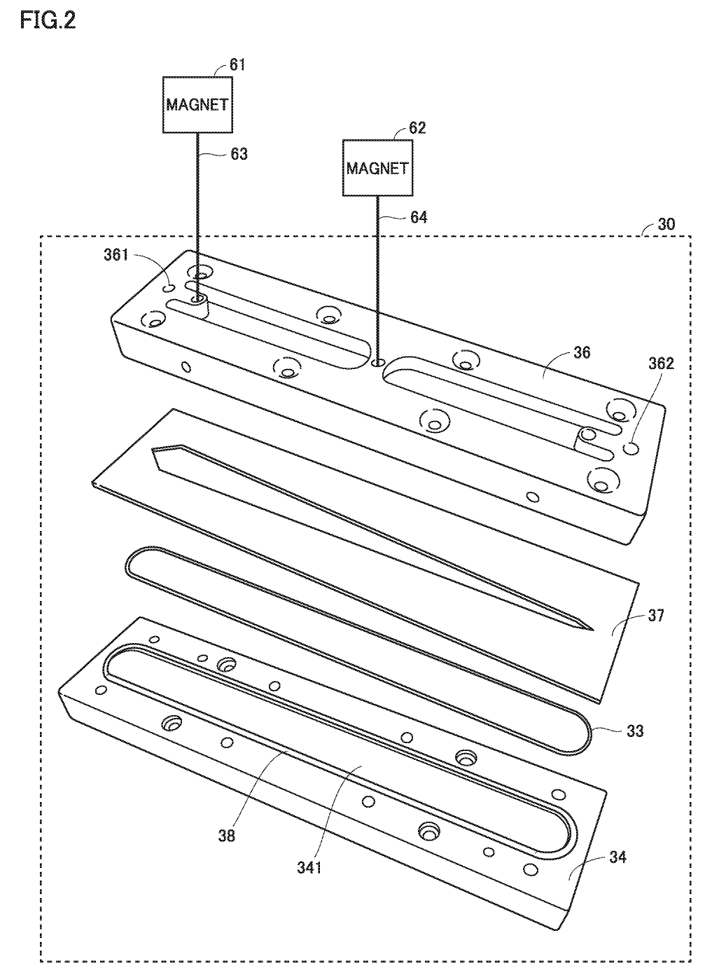

Next, the structure of the flow cell 30 will be described. FIG. 2 is an exploded perspective view showing the structure of the flow cell 30.

Referring to FIG. 2, the flow cell 30 includes a housing 36 and a spacer 37, in addition to the separation membrane 33 and the base 34. The flow cell 30 has a multilayer structure and is configured by stacking the base 34, the spacer 37, and the housing 36 in this order from the lower layer side. Through-holes for passing fixing bolts are provided at corresponding positions of the housing 36 and the base 34. Further, an O-ring 38, which is a sealing member, is sandwiched between the separation membrane 33 and the base 34. In FIG. 2, the fitting members 65 and 66 are not shown.

The housing 36 is a plate-shaped member. The housing 36 includes, for example, aluminum. The housing 36 is provided with a through-hole 361 in which the inlet port 31 is formed and a through-hole 362 in which the outlet port 32 is formed. In FIG. 2, the inlet port 31 and the outlet port 32 are not shown.

The spacer 37 is a flat plate made of, for example, PEEK (polyetheretherketone) resin or PET (polyethylene terephthalate). The spacer 37 has a space for forming the separation channel C. Specifically, the side walls of the separation channel C perpendicular to the XY plane are formed by the space of the spacer 37, the upper surface of the separation channel C is formed by the housing 36, and the lower surface of the separation channel C is formed by the separation membrane 33.

The O-ring 38 is fitted into a groove provided in the base 34. The O-ring 38 prevents the fluid that has passed through the separation membrane 33 from flowing to places other than the flow path in the base 34.

The base 34 includes a filter 341 through which the fluid that has passed through the separation membrane 33 passes. The fluid that has passed through the filter 341 passes through a flow path in the base 34 and is discharged from the discharge port 35.

FIG. 3 shows a cross-sectional view of the flow cell 30. FIG. 3 shows a cross-sectional view of the flow cell 30 in the YZ plane, on a plane including the magnet 61, the wire 63, and the fitting member 65.

Referring to FIG. 3, the wire 63 protrudes from the housing 36 into the separation channel C. This allows the magnetic field generated by the magnet 61 to be transmitted into the separation channel C. The length by which the wire 63 protrudes into the separation channel C is, for example, 0.1 mm. By applying a magnetic field to the separation channel C, the particles in the separation channel C are affected by the magnetic field. Specifically, for example, when a charged particle moves along the channel flow F1, a Lorentz force is generated on the charged particle. When the particle is a magnetic body, a magnetic force is generated on the particle.

Inside the base 34, a flow path P is formed through which the fluid that has passed through the separation membrane 33 and the filter 341 flows. The flow path P is connected to the discharge port 35. The flow rate of the flow path P is adjusted by the MFC 50.

### Comparative Example

As one of the methods for classifying fine particles in a solution, the AF4 (asymmetrical flow field-flow fractionation) method, which is a cross-flow type particle classification method employing an asymmetric channel structure, is known. The AF4 method forms a separation field by the flow of fluid and classifies particles in a sample according to their size.

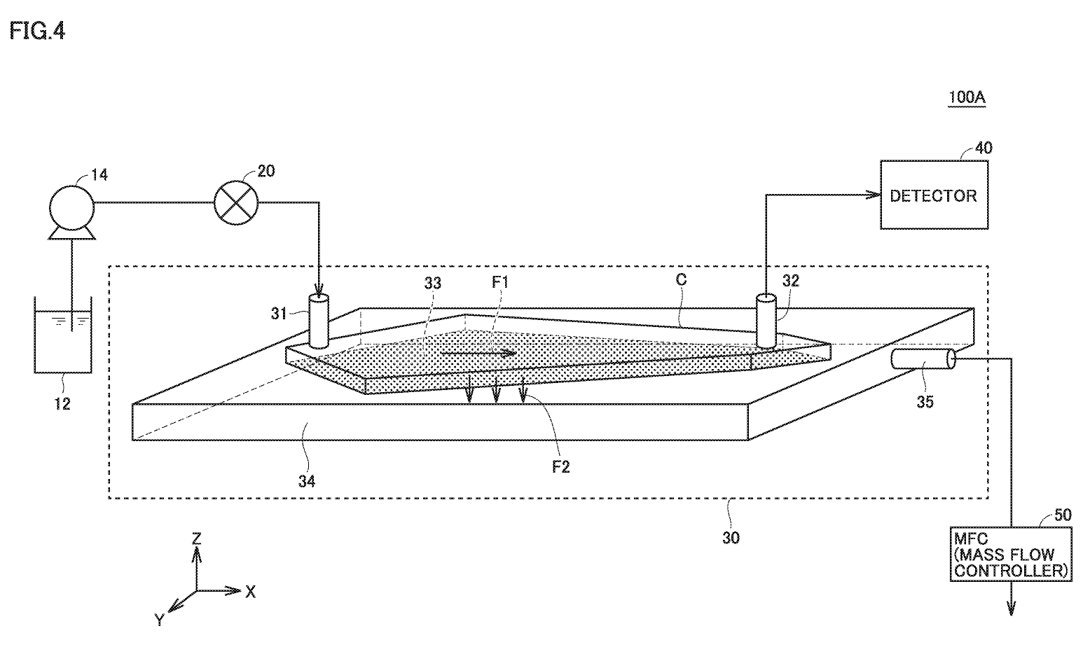

FIG. 4 is a diagram for explaining an FFF apparatus 100A in a comparative example. The FFF apparatus 100A shown in FIG. 4 is different from the FFF apparatus 100 shown in FIG. 1 in that it does not include the magnetic field generation unit 60.

In the AF4 method, a flow field is formed by generating a flow F1 in the X-axis direction and a flow F2 in the Z-axis direction inside the separation channel C. The particles in the sample introduced from the sample introduction unit 20 are pressed against the separation membrane 33 by the flow F2. Thereafter, when the flow rate of the flow F2 is reduced by the MFC 50, the particles pressed against the separation membrane 33 diffuse against the concentration gradient in a direction of lower concentration. It is known that nano- to submicron-sized particles have a diffusion coefficient that depends on their size. That is, the smaller the particle, the larger the diffusion coefficient. Therefore, smaller particles diffuse over a wider range. In the separation channel C, smaller particles reach a position farther away from the separation membrane 33, and as the size increases, they remain near the separation membrane 33 without diffusing.

Thereafter, by stopping the focus flow and causing the fluid to flow out in the direction of the outlet port 32 in the separation channel C, the particles are introduced into the detector 40. In the separation channel C, the flow of the fluid from the inlet port 31 to the outlet port 32 is a laminar flow, so the closer the layer is to the center in the Z-axis direction, the faster the flow velocity. Therefore, the smaller particles that have diffused to the vicinity of the central part in the Z-axis direction of the separation channel C are introduced into the detector 40 in order.

In this way, by using the AF4 method, particles contained in a sample can be classified depending on their size. However, as described above, in the AF4 method, particles are classified by utilizing the difference in diffusion coefficients due to the particle size, so it may be difficult to separate different types of particles with substantially the same particle size. Therefore, with the FFF apparatus 100A, it may be difficult to classify, for example, multiple types of particles with substantially the same particle size where one is charged and the other is not, or multiple types of particles with substantially the same particle size where one has magnetic properties and the other does not.

### Field Flow Fractionation Apparatus in the Embodiment

Therefore, the FFF apparatus 100 in the present embodiment includes the magnetic field generation unit 60 that generates a magnetic field acting on the separation channel C. This allows the FFF apparatus 100 to classify multiple types of particles even if they have substantially the same particle size, when the multiple types of particles in the separation channel C exhibit different behaviors with respect to a magnetic field (for example, one is charged and the other is not, or one has magnetic properties and the other does not).

Specifically, for example, when a particle is a charged particle, a Lorentz force is applied to the charged particle when it moves through the separation channel C along the flow F1. That is, of two types of particles, one charged and the other not, the charged particle is subjected to a Lorentz force, so its elution time from the separation channel C is delayed. Therefore, the FFF apparatus 100 can separate two types of particles with substantially the same particle size, where one is charged and the other is not. Even for two types of particles with different charge states, their behavior with respect to a magnetic field is different, so the FFF apparatus 100 can separate those two types of particles. Different charge states mean, for example, that the magnitude of the charge is different and/or the sign of the charge is different.

When a particle is a magnetic body, a magnetic force is applied to the particle when it moves through the separation channel C along the flow F1 or when it is pressed against the separation membrane 33 by the flow F2. That is, of two types of particles, one with magnetic properties and the other without, the particle with magnetic properties is subjected to a magnetic force, so its behavior in the separation channel C is different from that of the particle without magnetic properties. Therefore, the FFF apparatus 100 can separate two types of particles with substantially the same particle size, where one has magnetic properties and the other does not.

As described above, according to the FFF apparatus 100 of the present embodiment, it is possible to separate two types of particles that exhibit different behaviors with respect to a magnetic field but have substantially the same particle size.

### Particle Classification Method

A method for classifying particles using the FFF apparatus 100 will be described. FIG. 5 is a flowchart for explaining the particle classification method by the FFF apparatus 100. In FIG. 5, the sample contains particle A, which is a charged particle, and particle B, which has the same particle size as particle A but is not charged. Particle A and particle B are an example of two types of particles, one charged and the other not, and are also an example of multiple types of particles that exhibit different behaviors with respect to a magnetic field but have substantially the same particle size.

In step S10, the user introduces a sample from the sample introduction unit 20. Particle A and particle B in the introduced sample are introduced into the separation channel C from the inlet port 31 together with the fluid sent by the liquid feed pump 14. At that time, particle A and particle B undergo random self-diffusion in the separation channel C. Therefore, particle A and particle B are distributed with a certain spread centered on the inlet port 31.

In step S12, the FFF apparatus 100 supplies the fluid sent by the liquid feed pump 14 to the separation channel C. The supplied fluid passes through the separation membrane 33. This generates a cross-flow, and particle A and particle B are pressed against the separation membrane 33.

In step S14, the FFF apparatus 100 reduces the flow rate of the fluid discharged from the discharge port 35 by the MFC 50. This reduces the flow rate of the cross-flow. As a result, particle A and particle B, which were pressed against the separation membrane 33, diffuse in a direction away from the separation membrane 33. In general, the diffusion coefficient, which is a proportionality constant representing the speed of diffusion of particles in a medium, depends on the size (particle size) of the particles. Since the particle sizes of particle A and particle B are equal, their diffusion coefficients are the same. Therefore, particle A and particle B diffuse similarly.

In step S16, the FFF apparatus 100 causes the particles in the separation channel C to flow out to the outlet port 32 by the channel flow. In the separation channel C, the channel flow becomes a laminar flow. Here, the magnetic field generation unit 60 generates a magnetic field that acts on the separation channel C. Therefore, when particle A, which is a charged particle, moves through the separation channel C by the channel flow, a Lorentz force is applied to particle A. Therefore, while particle B moves along the channel flow in the separation channel C, particle A moves in a direction deviating from the channel flow due to the Lorentz force. This causes particle A to take a longer time to reach the outlet port 32 compared to particle B, so the retention time of particle A becomes longer than that of particle B.

In step S18, the FFF apparatus 100 detects the particles eluted from the outlet port 32 with the detector 40. The detector 40 creates a fractogram. Thereafter, the FFF apparatus 100 ends the processing of FIG. 5.

Although the FFF apparatus 100 in the present embodiment has been described with an example in which it includes two magnets, the magnet 61 and the magnet 62, as the magnetic field generation unit 60, the magnetic field generation unit 60 is not limited to this as long as it can generate a magnetic field that acts on the separation channel C. The magnet is not limited to a permanent magnet and may be an electromagnet. The number of magnets included in the magnetic field generation unit 60 is not limited to two, and may be one, or three or more. The magnetic field generation unit 60 may include a permanent magnet and an electromagnet.

In general, an electromagnet is larger in size than a permanent magnet. Therefore, the FFF apparatus can be made more compact when the magnetic field generation unit includes a permanent magnet compared to when it includes an electromagnet. Also, since power needs to be supplied to the electromagnet to generate a magnetic field, the user needs to prepare a power source for the electromagnet, but there is no need to supply power to a permanent magnet. Therefore, an FFF apparatus with a configuration that includes a permanent magnet in the magnetic field generation unit can reduce the user's workload compared to an FFF apparatus with a configuration that includes an electromagnet.

The magnetic field acting on the flow cell is a constant magnetic field when a permanent magnet is used, but when an electromagnet is used, the strength of the magnetic field is variable depending on the strength of the current in the electromagnet. Therefore, when using an FFF apparatus with a configuration that includes an electromagnet in the magnetic field generation unit, the user needs to control the strength of the current, which may increase the user's workload compared to using an FFF apparatus with a configuration that includes a permanent magnet. On the other hand, when an electromagnet is used, it is possible to control the strength of the magnetic field acting on the flow cell by controlling the current flowing through the electromagnet. Therefore, it is possible to make the Lorentz force or magnetic force acting on the particles stronger by making the magnetic field stronger than when using a permanent magnet, and to control the timing at which the magnetic force is applied.

In the FFF apparatus 100 of the present embodiment, an example has been described in which the magnet 61 and the magnet 62 are disposed on the upper side in the Z-axis direction with respect to the flow cell 30, but the position where the magnet is disposed is not particularly limited, and it may be on the side of the flow cell 30 or on the lower side of the flow cell 30. When the FFF apparatus 100 has a plurality of magnets, these magnets may be disposed on the same plane or on different planes. For example, some of the plurality of magnets may be disposed on the upper side of the flow cell 30, and the remaining magnets may be disposed on the lower side of the flow cell 30.

The magnitude of the Lorentz force changes depending on the component of the magnetic field orthogonal to the motion of the charged particle. The charged particle moves along the channel flow. Therefore, when the magnetic field is formed along a direction orthogonal to the channel flow, a larger Lorentz force can be generated compared to when it is formed along other directions. When the Lorentz force becomes larger, the charged particle moves by bending more significantly with respect to the channel flow, so the retention time of the charged particle can be made longer. For example, when the inlet port 31 and the outlet port 32 are disposed along the X-axis direction, it is preferable that a first magnetic body and a second magnetic body are disposed along the Z-axis direction so as to sandwich the separation channel C, and further, that a first pole of the first magnetic body and a second pole of the second magnetic body face each other. The first magnetic body and the second magnetic body are, for example, a permanent magnet and an electromagnet. When the first pole is an N pole, the second pole represents an S pole, and when the first pole is an S pole, the second pole represents an N pole.

According to the FFF apparatus 100 of the present embodiment, by generating a magnetic field that acts on the separation channel C, which is a flow channel through which the fluid and particles flow, it is possible to separate multiple types of particles that exhibit different behaviors with respect to a magnetic field.

### Modified Example

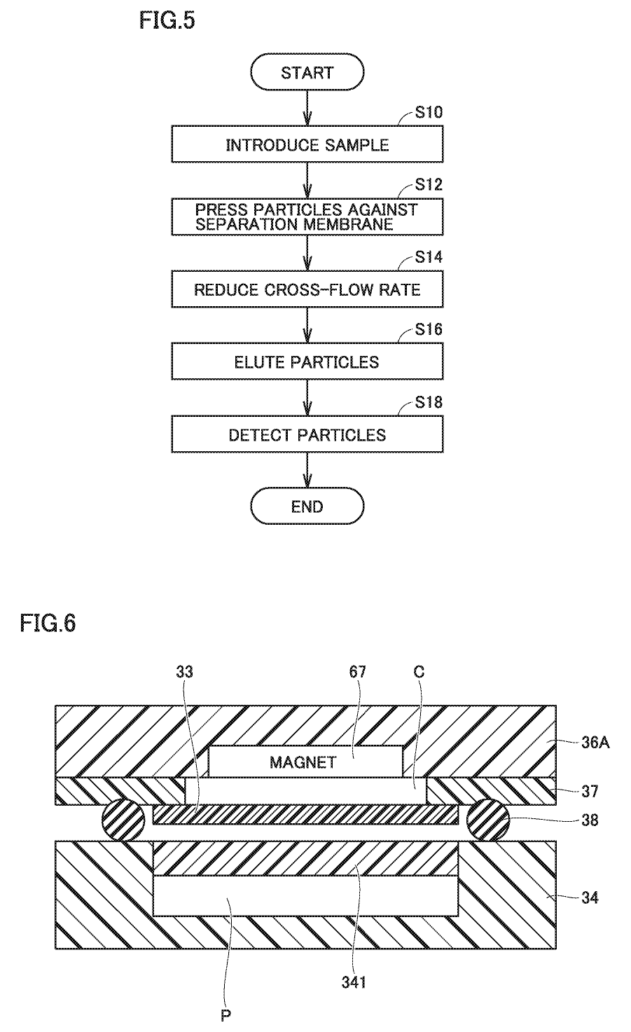

In the above-described embodiment, an example was described in which the magnet 61 and the magnet 62 are disposed outside the flow cell 30. In the FFF apparatus of the modified example, the magnetic field generation unit is disposed inside the flow cell. FIG. 6 shows a cross-sectional view of the flow cell according to the modified example.

As shown in FIG. 6, a magnet 67, which is a plate-shaped magnet serving as a magnetic field generation unit, is disposed in the housing 36A of the flow cell according to the modified example. This makes it possible to generate a magnetic field that acts on the separation channel C within the flow cell 30A.

The position where the plate-shaped magnet 67 is disposed is not limited as long as it can generate a magnetic field that acts on the separation channel C, but it is preferably disposed on a part of the wall surface of the separation channel C. For example, if a housing is disposed between the magnet 67 and the separation channel C, the distance between the separation channel C and the magnet 67 increases, and the magnetic field applied from the magnet 67 to the separation channel C weakens depending on that distance. By disposing the magnet 67 on a part of the wall surface of the separation channel C, the magnet 67 is disposed close to the separation channel C, so it is possible to prevent the magnetic field applied to the separation channel C from weakening. When the magnet 67 is disposed on a part of the wall surface of the separation channel C, it is preferable that the wall surface of the separation channel C and the magnet 67 are flush. If there are irregularities on the wall surface of the separation channel C, the flow of fluid in the separation channel C may be disturbed, and the particle classification accuracy may decrease. By arranging the wall surface of the separation channel C and the magnet 67 to be flush, it is possible to prevent the flow of fluid in the separation channel C from being disturbed.

### Experimental Example

Hereinafter, as an experimental example, an example of the present invention will be described in more detail together with a comparative example. The following description is an explanation of an example of the present invention, and the present invention is not limited to the example described below. In the experimental example, an FFF apparatus equipped with a magnetic field generation unit that generates a magnetic field acting on the separation channel (Example) and an FFF apparatus not equipped with a magnetic field generation unit (Comparative Example) were prepared. Using these, a sample containing ferritin and a sample containing apoferritin were each classified. An ultraviolet detector was used to detect the particles eluted from the outlet port. A fractogram was created based on the absorbance at a wavelength of 254 nm. The ferritin and apoferritin used in the experimental example were manufactured by Sigma-Aldrich.

Ferritin is a spherical protein with an outer diameter of 12 nm composed of 24 monomers. Ferritin contains trivalent iron ions inside. Apoferritin, like ferritin, is a spherical protein with an outer diameter of 12 nm composed of 24 monomers, but unlike ferritin, it does not contain iron ions. The zeta potential of ferritin is -35 mV, and ferritin has a negative charge. Ferritin and apoferritin are an example of two types of particles, one charged and the other not, and are also an example of multiple types of particles that exhibit different behaviors with respect to a magnetic field but have substantially the same particle size.

In the experimental example, 10 μL of 20 μg/mL ferritin was injected into each of the FFF apparatus according to the example and the FFF apparatus according to the comparative example, and a fractogram was created. Further, 10 μL or 20 μL of 1 mg/mL apoferritin was injected into each of the FFF apparatus according to the example and the FFF apparatus according to the comparative example, and a fractogram was created.

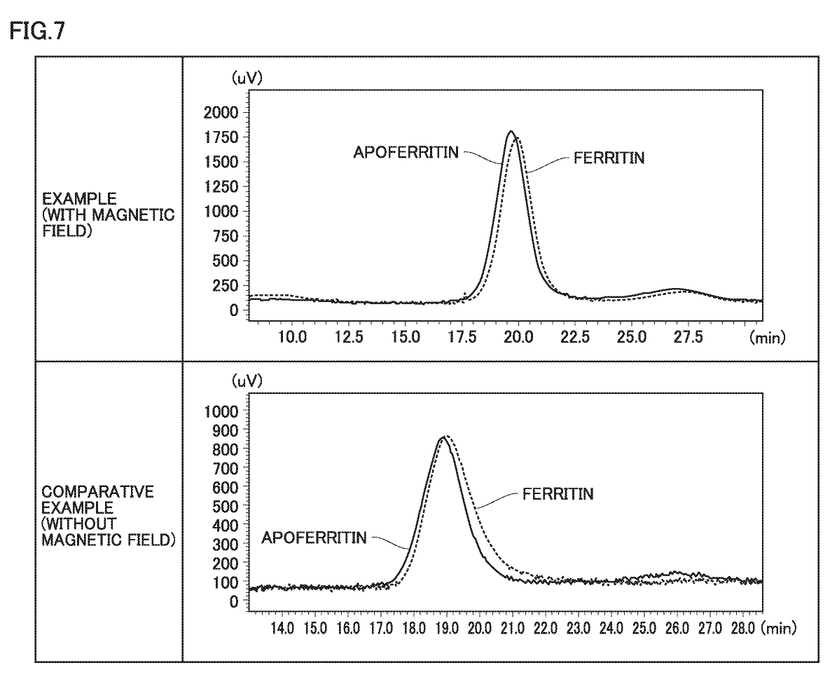

FIG. 7 is a diagram showing the fractograms in the experimental example. In the FFF apparatus according to the example, the retention time of ferritin was 19.69 min, and the retention time of apoferritin was 19.41 min. The difference between these retention times is 0.28 min. In the FFF apparatus according to the comparative example, the retention time of ferritin was 18.92 min, and the retention time of apoferritin was 18.80 min. The difference between these retention times is 0.12 min. In the example, the difference in retention times between ferritin and apoferritin is larger compared to the comparative example. This makes it possible for the FFF apparatus in the example to separate ferritin and apoferritin. From the above, according to the FFF apparatus equipped with the magnetic field generation unit in the example, it is possible to separate two types of particles that exhibit different behaviors with respect to a magnetic field but have substantially the same particle size.

### Aspects

It will be understood by those skilled in the art that the plurality of exemplary embodiments described above are specific examples of the following aspects.

(Item 1) A field flow fractionation apparatus according to one aspect may be a field flow fractionation apparatus for classifying particles contained in a sample, the apparatus comprising: a flow cell that constitutes a flow channel through which the particles flow; a fluid supply unit that supplies a fluid to the flow channel; a sample introduction unit that introduces the sample into the flow channel; and a magnetic field generation unit that generates a magnetic field acting on the flow channel.

According to the field flow fractionation apparatus described in Item 1, it is possible to separate multiple types of particles that exhibit different behaviors with respect to a magnetic field.

(Item 2) In the field flow fractionation apparatus described in Item 1, the magnetic field generation unit may include a permanent magnet.

According to the field flow fractionation apparatus described in Item 2, a constant magnetic field generated from the permanent magnet of the magnetic field generation unit acts on the flow cell. Since operations such as passing a current through the magnetic field generation unit are unnecessary, the user's workload can be reduced.

(Item 3) In the field flow fractionation apparatus described in Item 2, the magnetic field generation unit may further include a transmission member that is a magnetic body, one end of which is in contact with the permanent magnet, and the other end of which protrudes into the flow channel through a hole provided in the flow cell.

According to the field flow fractionation apparatus described in Item 3, a magnetic field can be applied to the flow channel (separation channel) of the flow cell by the transmission member, which is a magnetic body. When the flow cell is covered with a housing made of, for example, acrylic, even if a magnet is placed near the flow cell, the generated magnetic field may not act on the flow channel. Even in such a case, the transmission member allows the magnetic field generated from the permanent magnet to act on the flow channel in the flow cell.

(Item 4) In the field flow fractionation apparatus described in Item 2 or Item 3, the permanent magnet may be disposed on a wall surface of the flow channel.

According to the field flow fractionation apparatus described in Item 4, the magnetic field generated from the permanent magnet can be applied to the flow channel in the flow cell.

(Item 5) In the field flow fractionation apparatus described in any one of Items 2 to 4, the permanent magnet may be a neodymium magnet.

According to the field flow fractionation apparatus described in Item 5, a neodymium magnet, which has a higher magnetic force than other permanent magnets, is used. This allows a stronger magnetic field to be applied to the flow channel in the flow cell compared to when other permanent magnets are used. When a stronger magnetic field is applied to the flow channel in the flow cell, the behaviors of two types of particles that exhibit different behaviors with respect to a magnetic field become more different. Therefore, even two types of particles with a small difference in behavior with respect to a magnetic field can be separated.

(Item 6) In the field flow fractionation apparatus described in Item 5, the neodymium magnet may be 0.2 tesla (T) or more.

(Item 7) In the field flow fractionation apparatus described in any one of Items 1 to 6, the flow cell may include an inlet port and an outlet port for the flow channel, the inlet port and the outlet port may be disposed along a first direction, the magnetic field generation unit may include a first magnetic member and a second magnetic member, and a first pole of the first magnetic member and a second pole different from the first pole of the second magnetic member may be disposed along a second direction intersecting the first direction.

According to the field flow fractionation apparatus described in Item 7, a first pole of a magnet, which is a magnetic member, and a second pole opposite to the first pole of the magnet are disposed so as to face each other, sandwiching the flow channel of the flow cell. As a result, a magnetic field is formed in the flow cell in a second direction intersecting the first direction in which the inlet port and the outlet port are disposed. A magnetic field formed along the second direction can generate a larger Lorentz force on a charged particle moving along the first direction than a magnetic field formed along other directions. This makes the behaviors of two types of particles that exhibit different behaviors with respect to a magnetic field more different. Therefore, even two types of particles with a small difference in behavior with respect to a magnetic field can be separated.

(Item 8) In the field flow fractionation apparatus described in any one of Items 1 to 7, the magnetic field generation unit may include an electromagnet.

According to the field flow fractionation apparatus described in Item 8, a magnetic field generated from the electromagnet of the magnetic field generation unit acts on the flow cell. By controlling the magnitude of the current flowing through the electromagnet, the strength of the magnetic field acting on the flow cell can be controlled.

It should be understood that the embodiments disclosed herein are illustrative in all respects and not restrictive. The scope of the present disclosure is indicated by the claims rather than by the description of the embodiments above, and is intended to include all modifications within the meaning and scope equivalent to the claims. Further, it is intended that each technology in the embodiments can be implemented alone or in combination with other technologies in the embodiments as necessary.

### REFERENCE SIGNS LIST

12 container, 14 liquid feed pump, 20 sample introduction unit, 30 flow cell, 31 inlet port, 32 outlet port, 33 separation membrane, 34 base, 35 discharge port, 36, 36A housing, 37 spacer, 38 O-ring, 40 detector, 60 magnetic field generation unit, 61, 62, 67 magnet, 63, 64 wire, 65, 66 fitting member, 100 field flow fractionation apparatus.

1. A field flow fractionation apparatus for classifying particles contained in a sample, the apparatus comprising:
a flow cell that constitutes a flow channel through which the particles flow;
a fluid supply unit that supplies a fluid to the flow channel;
a sample introduction unit that introduces the sample into the flow channel; and
a magnetic field generation unit that generates a magnetic field acting on the flow channel.

2. The field flow fractionation apparatus according to claim 1, wherein the magnetic field generation unit includes a permanent magnet.

3. The field flow fractionation apparatus according to claim 2, wherein the magnetic field generation unit further includes a transmission member that is a magnetic body, one end of which is in contact with the permanent magnet, and the other end of which protrudes into the flow channel through a hole provided in the flow cell.

4. The field flow fractionation apparatus according to claim 2, wherein the permanent magnet is disposed on a wall surface of the flow channel.

5. The field flow fractionation apparatus according to claim 2, wherein the permanent magnet is a neodymium magnet.

6. The field flow fractionation apparatus according to claim 5, wherein the neodymium magnet is 0.2 tesla (T) or more.

7. The field flow fractionation apparatus according to claim 1, wherein
the flow cell includes an inlet port and an outlet port for the flow channel,
the inlet port and the outlet port are disposed along a first direction,
the magnetic field generation unit includes a first magnetic member and a second magnetic member, and
a first pole of the first magnetic member and a second pole different from the first pole of the second magnetic member are disposed along a second direction intersecting the first direction.

8. The field flow fractionation apparatus according to claim 1, wherein the magnetic field generation unit includes an electromagnet.
